(19) United States
(12) Patent Application Publication
(10) Pub. No.: US 2025/0314094 A1
(43) Pub. Date: Oct. 9, 2025

(54) KEY

(71) Applicant: LIXIL Corporation, Tokyo (JP)

(72) Inventors: Fuminori AKIYAMA, Tokyo (JP); Takashi MITSUHASHI, Tokyo (JP)

(73) Assignee: LIXIL Corporation, Tokyo (JP)

(21) Appl. No.: 18/686,715

(22) PCT Filed: Aug. 26, 2022
(86) PCT No.: PCT/JP2022/032187

§ 371 Date: Jun. 16, 2025

(30) Foreign Application Priority Data
Aug. 31, 2021 (JP) 2021-141187

(51) Int. Cl. E05B 19/24; B41M 5/26

(52) U.S. Cl. CPC E05B 19/24; B41M 5/262

(57) ABSTRACT

The present invention addresses the problem of providing a key that allows key number information to be changed or added and that allows key information to be easily read. A key 1 has a key body 2 and key information 3 displayed on the surface of the key body 2. The key information 3 is a two-dimensional code 30 that can be read by a reading device. The two-dimensional code 30 is preferably displayed on a flat surface of the key body. The key body 2 has a tip end 2a that can be inserted into a lock and a base end 2b on the side opposite the tip end 2a; and the two-dimensional code 30 is preferably located on the base end 2b side and displayed on a flat base end surface 23 that extends in a direction Z that intersects the direction connecting the tip end 2a and the base end 2b.

### CROSS-REFERENCE TO RELATED APPLICATIONS

This application is a national stage application under 35 U.S.C. § 371 of International Application No. PCT/JP2022/032187, filed Aug. 26, 2022, which claims the priority of Japanese Application No. 2021-141187, filed Aug. 31, 2021. The entire contents of each priority application is incorporated herein by reference.

### FIELD OF THE DISCLOSURE

The present disclosure relates to a key.

### BACKGROUND OF THE DISCLOSURE

Conventionally, a key for opening and closing a lock of a door, a window, or the like of a house is assigned with a key number for management, and the key number differs from one set of a lock and a key to another. The key number is inscribed on a surface of the key (see, for example, Japanese Unexamined Patent Application, Publication No. H8-13871). Examples of methods for inscribing a key number on a surface of a key includes a method in which the key is mechanically engraved by way of pressing, a method in which laser printing is performed with an indelible ink, or a method in which laser marking is performed. Among them, mechanical press-engraving is widely used because a key number inscribed thereby has high durability against age deterioration.

### SUMMARY OF THE DISCLOSURE

In the case of the press-engraving, it may be difficult to add a digit to a key number at a later stage, depending on the configuration of the pressing machine. Furthermore, there is a disadvantage that the deformation of the machine at the time of engraving, uneven wear occurring during use, and the like make it likely for the engraved numbers and characters to be erroneously read.

The present disclosure relates to a key including a key body and key information shown on a surface of the key body, and the key information is a two-dimensional code readable by a reader device.

### BRIEF DESCRIPTION OF THE FIGURES

FIG. 1 is a perspective view illustrating a key according to an embodiment.

### DETAILED DESCRIPTION OF THE DISCLOSURE

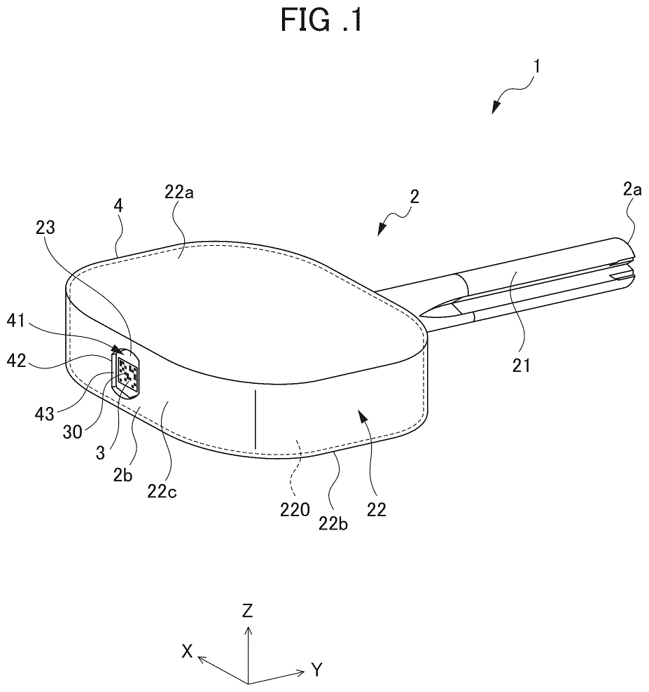

An Embodiment of the present disclosure will be described in detail with reference to the drawing. A key 1 is a member for opening and closing a lock (not shown) attached to a door, a window, or the like of a house, for example. As illustrated in FIG. 1, the key 1 includes a key body 2 and key information 3.

As illustrated in FIG. 1, the key body 2 includes a leading end 2a, a base end 2b, an insertion portion 21, a grip portion 22, and a base end surface 23. The leading end 2a is an end from which the key body 2 can be inserted into an opening of a lock. The base end 2b is an end of a side that is opposed to the leading end 2a of the key body 2 in a direction in which the insertion portion 21 is inserted, and that can be gripped when the key 1 is in use. The key body 2 has a shape longitudinally elongated in a direction connecting the leading end 2a and the base end 2b, and has a width and a thickness.

The insertion portion 21 is a long portion that is inserted into an opening of a cylinder of a lock to open and close the lock. The leading end of the insertion portion 21 constitutes the leading end 2a of the key body 2. The insertion portion 21 is processed to conform to an internal shape of the lock and as required for the key 1 to open and close the lock. The insertion portion 21 may have, for example, a notch as illustrated in FIG. 1, a saw-toothed part, or depressions as those of a so-called dimple key.

The grip portion 22 is located on a side of the key body 2 where the base end 2b resides, and can be gripped during use. The base end of the grip portion 22 constitutes the base end 2b of the key body 2. As illustrated in FIG. 1, the grip portion 22 has a flat shape that can be held by fingertips during use, and is formed in, for example, a thin rectangular parallelepiped shape with rounded corners. The grip portion 22 has a grip front surface 22a, a grip back surface 22b, and a grip end surface 22c, and is constituted by a grip body 220 and a cover member 4.

The grip front surface 22a and the grip back surface 22b are flat surfaces. The grip front surface 22a and the grip back surface 22b may have, for example, a rounded rectangular shape in a plan view. The grip end surface 22c is a surface connecting the grip front surface 22a and the grip back surface 22b. The grip end surface 22c is located on the side of the key body 2 where the base end 2b resides, and extends in a thickness direction Z of the key body 2. In the present specification, the thickness direction Z is a direction intersecting with both a longitudinal direction Y connecting the base end 2b and the leading end 2a of the key body 2 and a width direction X in which the key body 2 has a shorter dimension than in the longitudinal direction Y and which is orthogonal to the longitudinal direction Y.

The grip body 220 is a metal portion continuous and integrated with the insertion portion 21. The grip body 220 serves as a core that forms the shape of the grip portion 22. In FIG. 1, the grip body 220 is indicated by a broken line because the grip body 220 is covered with the cover member 4, which will be described later.

The base end surface 23 is a flat surface located on the side of the key body 2 where the base end 2b resides, and extends in the thickness direction Z of the key body 2. The base end surface 23 is located on a plane on a side of the grip body 220 where the grip end surface 22c resides, and is formed at a substantially center of the grip end surface 22c in the width direction X.

The cover member 4 is a resin member that covers the grip body 220, and the cover member 4 and the grip body 220 together form the grip portion 22. The cover member 4 constitutes the grip front surface 22a, the grip back surface 22b, and the grip end surface 22c excluding the base end surface 23. The cover member 4 has an opening 41, an edge 42, and a step 43. The opening 41 is a polygonal through hole formed in a portion corresponding to the base end surface 23 of the grip body 220. The edge 42 is a peripheral edge of the opening 41 and is disposed to surround the base end surface 23. The step 43 is formed between the edge 42 and the base end surface 23. That is, since the cover member 4 made of resin covers the grip body 220 made of metal, in the opening 41 where the base end surface is exposed, the base end surface 23 is located at a position recessed with respect to a peripheral portion belonging to the grip portion 22 and surrounding the base end surface 23. As a result, the step 43 corresponding to the thickness of the cover member 4 is provided between the base end surface 23 and the peripheral portion surrounding the base end surface 23.

The key information 3 is a two-dimensional code 30, and contains information in two directions: a vertical direction and a lateral direction. The two-dimensional code 30 may be, for example, a QR code (registered trademark). The key information 3 is planarly represented and shown on a plane of the key body 2. Specifically, the key information 3 is inscribed on the base end surface 23 by laser marking. The key information 3 is readable with a reader device such as an electronic device, examples of which include a smartphone and the like. The reader device is equipped with an automatic recognition technology, and includes a dedicated reading application installed therein. The key information 3 contains information necessary for duplicating the key, such as a management number unique to the key.

The present embodiment exerts the following effects. The key 1 includes the key body 2 and key information 3 shown on a surface of the key body 2, and the key information 3 is constituted by the two-dimensional code 30 readable by a reader device. The configuration in which the key information 3 is constituted by the two-dimensional code 30 readable by a reader device makes it easy to make a necessary change when the number of digits of a management number is increased or information to be assigned is changed at a later stage. The key information 3 constituted by the two-dimensional code 30 is more resistant to wear and deformation in comparison with key information inscribed by a mechanical method, thereby enabling accurate reading of the key information 3.

According to the present embodiment, the two-dimensional code 30 is shown on a plane of the key body 2. Due to this configuration, the key information 3 can be easily shown and read.

According to the present embodiment, the key body 2 includes the leading end 2a that can be inserted into a lock, and the base end 2b located opposite to the leading end 2a. The two-dimensional code 30 is shown on the base end surface 23 that is flat and located on a side where the base end 2b resides, and extends in the thickness direction Z intersecting with the direction connecting the leading end 2a and the base end 2b. In the case where the key 1 has the two-dimensional code 30 shown on the base end surface 23 extending in the thickness direction Z, it is difficult to clearly capture the two-dimensional code 30 in a photograph of the key 1 placed on a desk. In recent years, crimes have been committed using a key duplicated based on key information captured in a photograph of another person's key. Conventionally, in a case where key information is engraved on a plane of a grip portion, the key information is captured in a photograph taken in plan view. In contrast, showing the key information 3 on the base end surface 23 extending in the thickness direction Z of the key body 2 makes it difficult to see the key information 3 and to capture the key information 3 in a photograph, whereby the key 1 becomes more effective in crime prevention.

According to the present embodiment, the key body 2 includes, on the side where the base end 2b resides, the grip portion 22 that can be gripped during use. The base end surface 23 is located at a position recessed with respect to the peripheral portion in the grip portion 22 and surrounding the base end surface 23. Due to the configuration in which the base end surface 23 is located at the position recessed with respect to the peripheral portion surrounding the base end surface 23, and the step 43 is formed between the base end surface 23 and the peripheral portion surrounding the base end surface 23, when a user touches the surface extending in the thickness direction Z on the side where the base end 2b of the key 1 resides, the edge 42 around the base end surface 23 is touched. The user is prevented from touching the base end surface 23 located at the position recessed with respect to the edge 42. Thus, the two-dimensional cord 30 is resistant to deterioration caused by wear, and to adhesion of grime.

According to the present embodiment, the two-dimensional code 30 is inscribed by laser marking. Thus, even if the surface on which the key information 3 is to be inscribed has a small area, it is easy to accurately and reliably inscribe the key information 3.

The present disclosure is not limited to the above-described embodiment, and modifications, improvements, and the like that are made in the range in which the object of the present disclosure can be achieved are encompassed in the present disclosure. For example, a removable cap for covering the base end surface 23 may be provided at the position recessed with respect to the peripheral portion in the grip portion 22 and surrounding the base end surface 23. Due to this configuration, the two-dimensional code 30 is not exposed except when the two-dimensional code 30 is read, whereby wear and adhesion of grime can be further reliably prevented.

Although the cover member 4 made of resin covers the surfaces of the grip body 220 in the above embodiment, the cover member 4 may be omitted, and the entire key may be made of metal. In this case, the base end surface on which the key information 3 is shown is formed at a position recessed with respect to a peripheral portion in the metal grip portion and surrounding the base end surface. In other words, a configuration in which the peripheral portion belonging to the grip portion and surrounding the base end surface of the grip portion protrudes from the base end surface toward the base end makes it possible to protect the key information shown on the base end surface from wear and grime.

The grip portion 22 may have an oval shape, a fletching shape, or a substantially cylindrical shape having a diameter equal to that of the insertion portion 21. The shape of the grip portion 22 is determined according to the design of the key. The base end surface 23 is a flat surface in the above embodiment, but it may be a curved surface. The key information 3 is inscribed by laser marking in the above embodiment, but it may be printed by laser printing. The method of showing the key information 3 is not limited. Furthermore, the two-dimensional code is not limited to a QR code (registered trademark). The reader device may be a general-purpose device having functions in addition to a reading function, such as a smartphone, or may be a dedicated device that exclusively reads the key information 3. The reader device may read the two-dimensional code in an optical manner.

1. A key comprising:
a key body; and
key information shown on a surface of the key body, wherein the key information being a two-dimensional code readable by a reader device.

2. The key of claim 1, wherein
the two-dimensional code is shown on a plane of the key body.

3. The key of claim 1, wherein
the key body has a leading end insertable into a lock, and a base end located opposite to the leading end, and
the two-dimensional code is shown on a base end surface that is flat and located on a side where the base end resides, and that extends in a direction intersecting with a direction connecting the leading end and the base end.

4. The key of claim 3, wherein
the key body has, on the side where the base end resides, a grip portion which is able to be gripped when the key is in use, and
the base end surface is located at a position recessed with respect to a peripheral portion in the grip portion and surrounding the base end surface.

5. The key of claim 1, wherein
the two-dimensional code is inscribed by laser marking.

6. The key of claim 2, wherein
the key body has a leading end insertable into a lock, and a base end located opposite to the leading end, and
the two-dimensional code is shown on a base end surface that is flat and located on a side where the base end resides, and that extends in a direction intersecting with a direction connecting the leading end and the base end.

7. The key of claim 6, wherein
the key body has, on the side where the base end resides, a grip portion which is able to be gripped when the key is in use, and
the base end surface is located at a position recessed with respect to a peripheral portion in the grip portion and surrounding the base end surface.

8. The key of claim 2, wherein the two-dimensional code is inscribed by laser marking.

9. The key of claim 3, wherein the two-dimensional code is inscribed by laser marking.

10. The key of claim 6, wherein the two-dimensional code is inscribed by laser marking.

11. The key of claim 4, wherein the two-dimensional code is inscribed by laser marking.

12. The key of claim 7, wherein the two-dimensional code is inscribed by laser marking.

13. The key of claim 3, wherein the key body has a substantially cylindrical insertion portion.
